(19) United States
(12) Patent Application Publication
(10) Pub. No.: US 2008/0053915 A1
(43) Pub. Date: Mar. 6, 2008

(54) Method of processing liquid organic waste to solid fuel; greenhouse gas purification and oxidization

(75) Inventor: Caius Emeka Egbufoama, Laurel, MD (US)

Correspondence Address: BLANK ROME LLP, 600 NEW HAMPSHIRE AVENUE, N.W., WASHINGTON, DC, 20037, US

(73) Assignee: CAIUS EMEKA EGBUFOAMA

(21) Appl. No.: 11/518,702

(22) Filed: Sep. 11, 2006

Related U.S. Application Data
(63) Continuation of application No. 11/215,750, filed on Aug. 31, 2005.

(51) Int. Cl. C02F 1/52; C02F 1/72

(52) U.S. Cl. 210/713; 210/758; 210/759; 210/766

(57) ABSTRACT

A method of processing liquid organic waste, whereas sludge liquid is separated from sludge solid. The sludge solid is pasteurized and pumped into the formation unit. The heat gases (heart, emission, air pressure, ash, dust, and etcetera) force sludge solid to move more than one direction creating ocean waves look alike and the liquid substance in sludge solid is steamed out of the unit to designate location and the dried substance becomes an energy fuel product equivalent to coal.

### FIELD OF INVENTION

The present invention relate to a process for processing liquid organic waste to solid fuel and greenhouse gas (emission stack) purification and oxidization fluid gases to a single gas. I have full knowledge about using municipal and industrial waste such as manure, milk, raw sewer, and etcetera to produce methane gas, carbon dioxide, hydrogen sulfide, and ammonia. I am also aware of the current technology such as Scrubber to lower the emission stack. I was drawn into this invention by my interest in clean environment, global worming, health concerns, and alternative energy source. In my lab research and operating a pilot plant, I discovered ways to process liquid organic waste to solid energy fuel product and I also discovered a method to separate metals, solid from greenhouse gas; trap the fluid gases (carbon monoxide, carbon dioxide, sulfur dioxin, and excreta) for purification, neutralization, and oxidize the fluid gases to a single gas with foreign agent or agents and released into the environment at lower temperature and purified liquid that is environmental friendly.

### SUMMARY

The technology process converts liquid organic waste such as:- raw sewer, raw manure, and etcetera to solid eneregy producing products; whereas the greenhouse gas is processed by separating solid, metals for the fluid gas. The fluid gas (combination various gas agents) is purified, neutralized, and oxidized to a single gas. The gas is converted into liquid that is environmental friendly and releasaed at a room temperature depending on the atmospheric temperature. the solid and metals extracted from greenhouse gas is treated and released as an aggregated products.

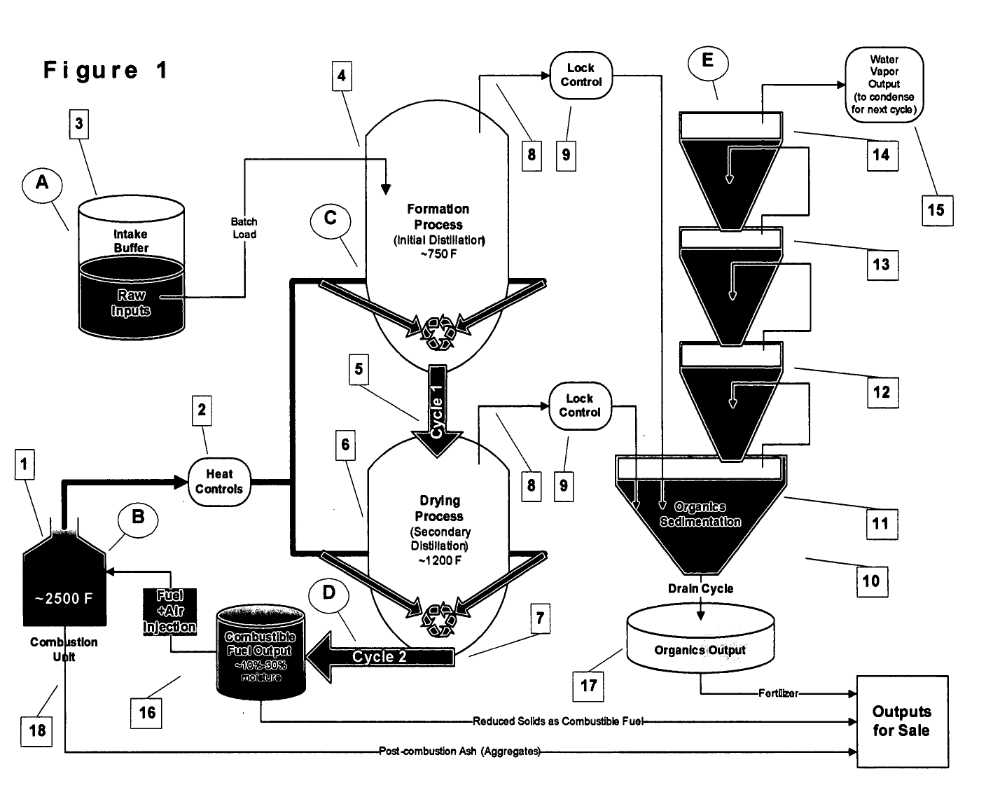

### COMPONENT IDENTIFICATION: FOR FIG. 1

1. Combustion Unit
2. Heat Control and Distribution
3. Intake Buffer
4. Formation Processor Tank
5. Drain (Cycle 1)
6. Drying Processor Tank
7. Drain (Cycle 2)
8. Distillate Outputs
9. Lock Controls for Distillate Piping
10. Staged Sedimentation Column
11. Stage 1 Sedimentation
12. Stage 2 Sedimentation
13. Stage 3 Sedimentation
14. Stage 4 Final Cooling
15. Vapor Output
16. Combustible Fuel Output
17. Sedimented Organic Output
18. Reduced Fuel (Ash) Output

### Process Annotation:

A) Inputs consist of
* Agricultural-Inputs, Following standard septic sedimentation
* CIVIL-Inputs, Following TBD waste treatment specs

B) Combustion Unit provides controlled high-temperature injection for both Formation and Drying processes.

C) Inputs are loaded into Formation tank, where most of the organics are distilled away. Heat injectors provide agitation to the base of the materials. Cycle 1 is perforrned when moisture content drops to specified threshold.

D) Drying process drives out remaining moisture to specified threshold. Cycle 2 drains reduced materials.

E) High-temperature distillates are cooled in stages where organic particulates are sedimented. Tanks are sealed, so distillate pressures force vapors up through each tank. When lowest tank is saturated, its organics are drained, and each higher tank is sequentially drained into the lower tank, and fresh (or condensed) water is added to the top tank. To keep production constant, the use 2 or more complete columns will allow drainage and service while one column remains in operation.

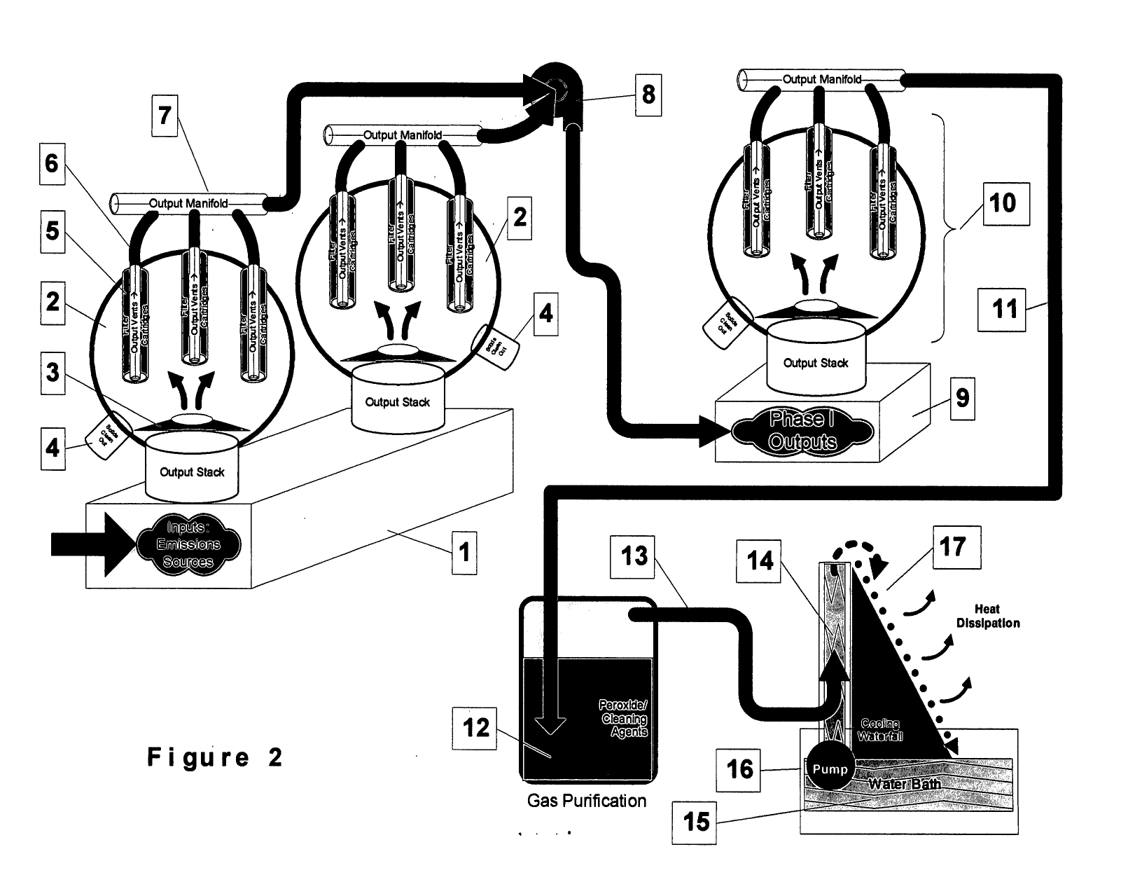

To purify the fluid gas from the water vapor out-put 15 (shown on FIG. 1 drawing), the fluid gas is collected in central collector (1), (shown on FIG. 2) before being fed into one of several parallel expansion chambers (2) which serve to lower the initial gas temperature by increasing the overall volume of the output stack.

Gases and particulates pass through a shroud (3) which collects particulates for removal during cleaning by a side cleanout port (4). Moistened fiber filters (5) surround vent tubes (6), which remove the majority of the first-stage particulates. These filters must be changed or cleaned in a regularly calculated cycle.

Gases leaving this stage are collected in manifolds (7) which join the outputs of all parallel expansion chambers prior to feeding into a blower unit (8) which maintains negative pressure in all the output manifolds and feeds the combined “Phase 1” outputs into the secondary collector (9). The scrubbing process is repeated again in its entirety through the secondary scrubber system (10).

The output gases (Sulfur Dioxin, CO, C02, etc.) of the secondary scrubber (11) are percolated through a Gas Purification tank (12) containing Peroxide, lime and other active agents which neutralize the injected gases. The percolated gas output of the Gas Purification tank (13) is infused into a stream of coolant water (14) which is recirculated from a Water Bath (15) by a Pump (16). The coolant waterdissipates its heat by flowing down a staged waterfall (17). Furthermore, the process and purification of greenhouse gases can be implemented at stage 1 sedimentation.

What I claim:

1. I am claiming the method of processing liquid organic waste, whereas sludge liquid is separated from sludge solid. The sludge solid is pasteurized and pumped into the formation Unit. The heat gases (heat, emission, air pressure, ash, dust, and etcetera) force sludge solid. to move more than one direction creating ocean waves look alike and the liquid substance in sludge solid is steamed out of the unit to designated location and the dried substance becomes an energy fuel product equivalent to coal.

2. (1) I am claiming the method of processing greenhouse gases, whereas cotton fiber or pervious slab is used to separate the metals and solid from fluid gases. The gases are injected into a purification agents or agent in the Purification Tank for neutralization and oxidized into a peroxide gas.
(11) I am claiming the method of process, whereas peroxide and lime are used as purification, neutralization, and oxidization agents to oxidize fluid gases to a peroxide agent.
(111) I am claiming the method of process to cool fluid gas whereas the percolated gas output of the Gas Purification Tank is infused into a s stream of coolant water which is recirculated from a Water Bath by a pump. The coolant water dissipates its heat by flowing down a staged water fall
